(19) United States
(12) Patent Application Publication
(10) Pub. No.: US 2020/0396066 A1
(43) Pub. Date: Dec. 17, 2020

(54) METHOD OF ESTABLISHING A CRYPTOGRAPHIC KEY SHARED BETWEEN A FIRST AND A SECOND TERMINAL

(71) Applicant: Viaccess, Paris (FR)

(72) Inventors: Mathieu Boivin, Aulnay-sous-Bois (FR); Gilles Dubroeucq, Saint Piat (FR)

(21) Appl. No.: 16/957,201

(22) PCT Filed: Dec. 20, 2018
(86) PCT No.: PCT/FR2018/053481

§ 371 Date: Jun. 23, 2020

(30) Foreign Application Priority Data
Dec. 29, 2017 (FR) 1763371

(51) Int. Cl. H04L 9/08; H04L 9/14

(52) U.S. Cl. CPC H04L 9/0822; H04L 9/0838; H04L 2209/80; H04L 9/0869; H04L 9/14; H04L 9/0866

(57) ABSTRACT

Method in which:
a first terminal transmits K cryptograms KA*_{k,20} and a digital imprint KA₂₀-Check of a key KA₂₀, each cryptogram KA*_{k,20} having been obtained by encrypting the key KA₂₀ with the aid of a respective key KS_{k,20} constructed on the basis of a characteristic datum extracted from electromagnetic waves received by this first terminal,
a second terminal:
   decrypts each cryptogram KA*_{k,20} received with the aid of a key KS_{m,22} and thus obtains a key KA₂₂, each key KS_{m,22} having been constructed by proceeding just as for the keys KS_{k,20} but by using the characteristic data extracted from electromagnetic waves received by this second terminal,
   constructs a digital imprint KA₂₂-Check of each key KA₂₂,
   only for the key KA₂₂ obtained for which the digital imprints KA₂₀-Check and KA₂₂-Check are identical, stores this key KA₂₂ as being the key shared with the first terminal.

The invention relates to a method of establishing a cryptographic key shared between a first and a second terminal. The invention also relates to methods for the execution, by the first terminal and the second terminal respectively, of the steps required for implementing the method of establishing a shared cryptographic key. Finally, the invention also relates to a data recording medium and to a first and a second terminal for implementing this method of establishment.

There are many situations in which it is necessary to establish a cryptographic key shared between two terminals. “Shared cryptographic key” denotes a secret cryptographic key that is known to these two terminals only. This cryptographic key makes it possible, for example, to establish a secure link for exchanges of data between these two terminals. Specifically, these data may then be, for example, encrypted with the shared cryptographic key by one of the terminals, before being transmitted over a data transmission network, and then decrypted, with the same shared cryptographic key, by the other terminal when it receives these data.

There are also situations in which it must not be possible to establish such a secure data exchange link unless, additionally, the two terminals are in the proximity of one another, that is to say geographically close to one another.

The following documents are known in the prior art:
WO97/49213A1,
US2014/219449A1,
Menezes A. J. et al: Handbook of applied cryptography, Chapter 12: Key Establishment Protocols, CRC Press, Boca Raton, Fla., US, Pages 489-541,
US2011/045780A1.
   In particular, WO97/49213A1 and US2014/219449A1 describe how to establish a cryptographic key shared between two terminals, using for this purpose measurements of the physical properties of the communication channel established between these two terminals. These methods do not make it possible to make the establishment of the shared cryptographic key conditional on the fact that the terminals are geographically in the proximity of one another.

The invention proposes a method, as claimed in claim 1, of establishing a cryptographic key KA₂₀ shared between a first and a second terminal, the establishment being conditional on the fact that these two terminals are in the proximity of one another.

The embodiments of this method of establishment may have one or more of the characteristics of the dependent claims.

The invention also relates to a method for the execution by the first terminal of the steps required for implementing the claimed method of establishing a shared cryptographic key.

The invention also relates to a method for the execution by the second terminal of the steps required for implementing the claimed method of establishing a shared cryptographic key.

The invention also relates to a data recording medium readable by a cryptoprocessor or a microprocessor, this medium comprising instructions for the implementation of the claimed method of establishment when these instructions are executed by this cryptoprocessor or this microprocessor.

The invention also relates to a first terminal for implementing the claimed method of establishment.

The invention also relates to a second terminal for implementing the claimed method of establishment.

The invention will be more readily understood from a perusal of the following description which is provided solely by way of non-limiting example, and which refers to the drawings, in which:

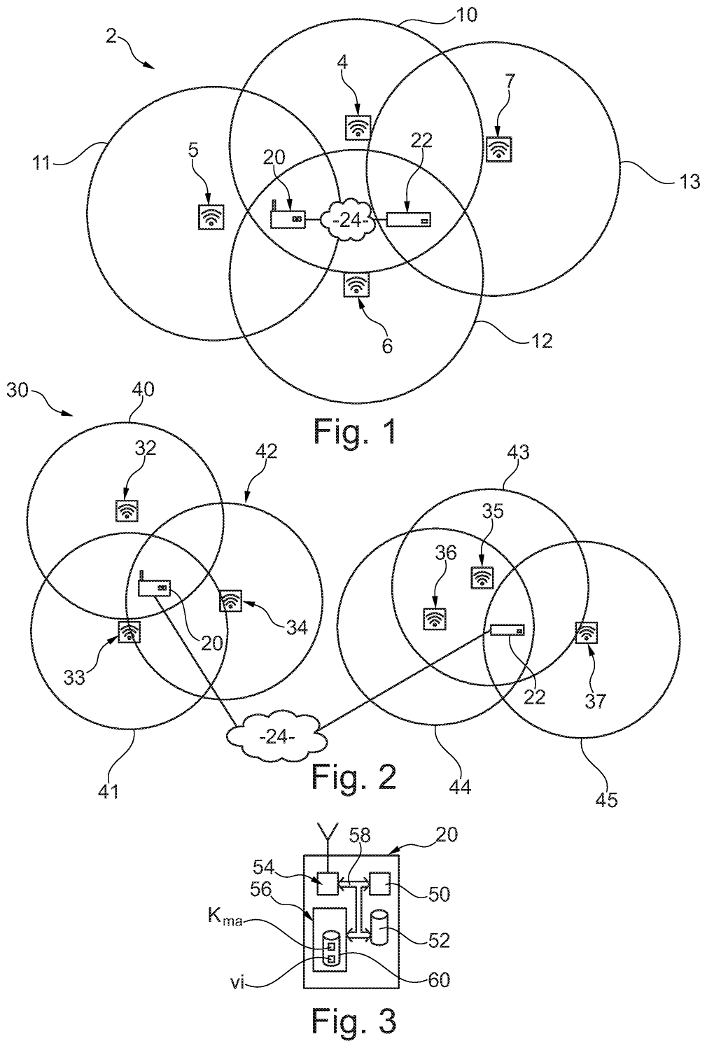

FIGS. 1 and 2 are schematic illustrations of two respective sets of wireless transmitters;

FIG. 3 is a schematic illustration of the architecture of a terminal;

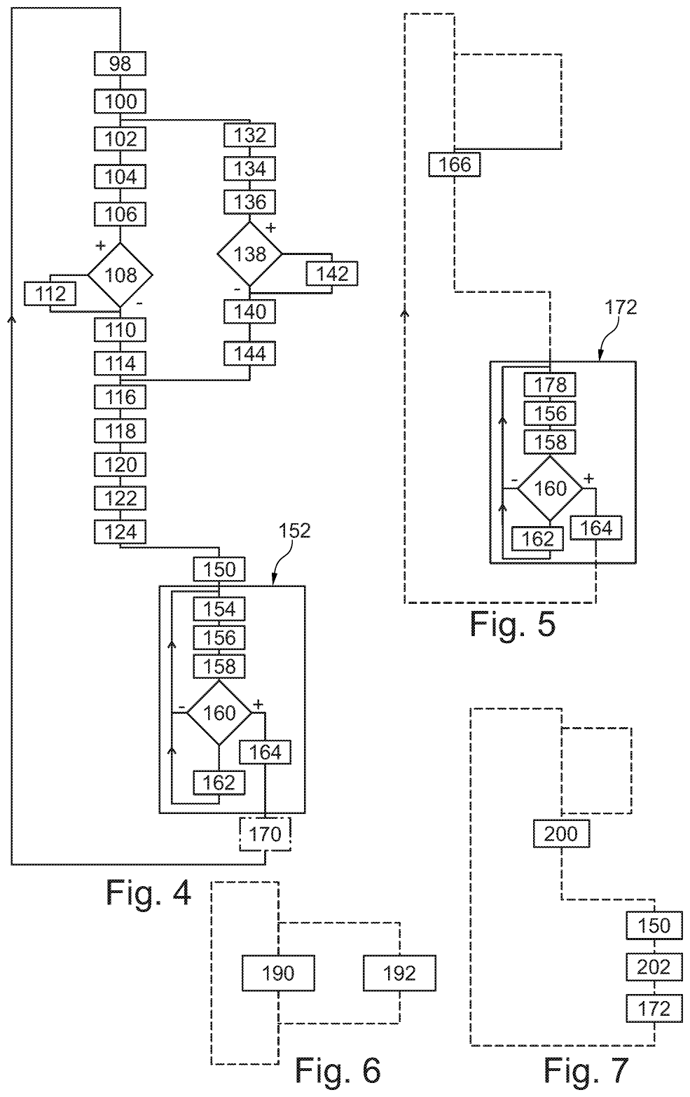

FIG. 4 is a flow diagram of a method of establishing a shared cryptographic key;

FIGS. 5 to 7 are schematic and partial illustrations of other possible embodiments of the method of FIG. 4.

In these figures, the same references are used to denote the same elements.

In the remainder of this description, characteristics and functions that are well known to those skilled in the art are not described in detail.

### CHAPTER I: EXAMPLES OF EMBODIMENTS

FIG. 1 shows a set 2 of wireless transmitters. In the particular case shown in FIG. 1, the set 2 comprises four wireless transmitters 4 to 7. Here, the transmitters 4 to 7 are, for example, each a WiFi access terminal, also known as an “access point” (or “hotspot”), according to the ISO/CEI 8802-11 standard for example. Each of these wireless transmitters enables a terminal to establish a wireless link with this transmitter, for the purpose, typically, of communicating with the other terminals which have established a wireless link with the same transmitter in a similar way. This wireless link is commonly called a “WiFi connection”. Thus, each wireless transmitter enables a local wireless network to be formed.

For this purpose, each wireless transmitter transmits electromagnetic waves, or “radio waves”, having a range of less than X meters. Typically, in the case of WiFi access terminals, X is less than or equal to 750 m or 500 m, or possibly even less than or equal to 350 m or 250 m. Usually, the range X is greater than 2 m or 10 m. Beyond this distance of X meters, the power of the transmitted electromagnetic waves is generally less than a detectability threshold Pₘᵢₙ, below which the electromagnetic waves cannot be detected or used by terminals. In this embodiment, for simplicity, it is assumed that the sensitivities of all the terminals are identical. Therefore, the sensitivity thresholds below which they cannot detect or use an electromagnetic wave transmitted by any of the transmitters 4 to 7 are all equal to Pₘᵢₙ. For example, in the case of a WiFi network, the threshold Pₘᵢₙ is equal to −80 dBm or −90 dBm or −100 dBm. Thus, the range of X meters corresponds to the distance beyond which the power of the electromagnetic waves transmitted by the wireless transmitter is below the threshold Pₘᵢₙ. In practice, this distance is not necessarily the same in all directions, because, for example, it depends on the presence of an obstacle or other interferences. However, in order to simplify FIG. 1, the distance X is assumed to be constant in each direction. Thus, the reception area within which a terminal can detect the presence of a wireless transmitter is represented by a circle centered on this wireless transmitter in FIG. 1. More precisely, in FIG. 1, these reception areas centered on the transmitters 4 to 7 bear the reference numerals 10 to 13, respectively. Subsequently, when a terminal is located within the reception area of a wireless transmitter, it will be said that this wireless transmitter is “in the range” of this terminal.

The electromagnetic waves transmitted by each transmitter are modulated on the basis of a characteristic data element of the wireless transmitter. Here, the characteristic data element is a data element which makes it possible to identify unambiguously the wireless transmitter that is transmitting these electromagnetic waves, among the set of the wireless transmitters of the set 2. This characteristic data element will subsequently be denoted Idᵢ, where the index i is an identifier of the wireless transmitter. For example, in the case of WiFi wireless transmitters, the electromagnetic waves transmitted by these transmitters are modulated, notably, on the basis of:
an SSID (“Service Set Identifier”) label corresponding to the name of the wireless network, and
the MAC (“Media Access Control”) address of the wireless transmitter.

These characteristic data elements of the transmitter may be extracted by each terminal capable of establishing a wireless connection with this transmitter. Subsequently, the main embodiments are described in the special case where the characteristic data element Idᵢ is the MAC address of the transmitter.

FIG. 1 also shows two terminals 20 and 22, each capable of detecting each of the transmitters 4 to 7. In the set 2, the terminal 20 is situated at a location where only the transmitters 4, 5 and 6 are in its range. The terminal 22 is situated at a location where only the transmitters 4, 6 and 7 are in its range.

The terminals 20 and 22 are also connected to one another by means of a network 24. The network 24 is, for example, a long-distance data transmission network. The network 24 may enable the terminals 20 and 22 to communicate with one another regardless of the distance separating them. Here, the network 24 is a network that operates independently of the set 2 of wireless transmitters. For example, the network 24 is a wireless telephone network or the Internet.

FIG. 2 shows the terminals 20 and 22 placed within another set 30 of wireless transmitters. The set 30 comprises six wireless transmitters 32 to 37. The transmitters 32 to 37 are, for example, structurally identical to the transmitters 4 to 7. The reception areas of the transmitters 32 to 37 bear the reference numerals 40 to 45, respectively.

As in FIG. 1, to simplify the representation of each of these reception areas, they are each shown in the form of a circle centered on the corresponding wireless transmitter.

In this set 30, the terminal 20 is situated at a location where only the transmitters 32 to 34 are in its range. The terminal 22 is situated at a location where only the transmitters to 37 are in its range.

FIG. 3 shows the architecture of the terminal 20. The terminal 20 comprises:
a conventional microprocessor 50,
a non-volatile memory 52,
a wireless transceiver 54,
a cryptoprocessor 56,
a bus 58 for data exchange between the aforesaid different components of the terminal 20.

The transceiver 54 is a WiFi transceiver capable of detecting and establishing a WiFi connection with any of the wireless transmitters of the sets 2 and 30. Authorization for access to the local network by such a wireless transmitter, or to the network 24 via this wireless transmitter, is commonly conditional on the fact that the terminal has the necessary access rights. However, even without having the necessary access rights, the transceiver 54 is capable of extracting the data element Idᵢ from the electromagnetic waves transmitted by the wireless transmitter.

The cryptoprocessor 56 is capable of executing data encryption and decryption functions, as well as hash functions. The cryptoprocessor 56 is designed to be more resistant to attempted cryptanalysis than, for example, the microprocessor 50. For this purpose, it comprises, notably, a secure non-volatile memory 60. The memory 60 is only accessible and readable by the cryptoprocessor 56. In particular, the memory 60 is not accessible and is not readable by the microprocessor 50. Here, the memory 60 stores a key Kₘₐ and an initialization vector VI. The memory 60 also stores instructions for executing the steps required for implementing any of the methods of FIGS. 4 to 7 when these instructions are executed by the cryptoprocessor 56. In this particular embodiment, the memory 60 comprises the set of instructions required to execute both the steps carried out by the terminal 20 and those carried out by the terminal 22. Thus, the roles of the terminals 20 and 22 may be reversed.

For simplicity, it is assumed that the architecture of the terminal 22 is identical to that of the terminal 20. In particular, the secure non-volatile memory of the terminal 22 also comprises the key Kₘₐ and the vector VI.

The operation of the terminals 20 and 22 for establishing a shared cryptographic key KA₂₀ will now be described with reference to the method of FIG. 4. The method of FIG. 4 is described in the particular case where the terminals 20 and 22 act, respectively, as master and slave terminals. The master terminal is the one that launches the method of establishing the shared key KA₂₀.

In a step 98, the terminals 20 and 22 are each placed in one or more reception areas of a set of wireless transmitters such as those described with reference to FIGS. 1 and 2. Here, each wireless transmitter constantly transmits electromagnetic waves from which the characteristic data elements Idᵢ may be extracted.

In a step 100, the terminal 20 transmits a synchronization signal to the terminal 22, for example, via the network 24.

Then, Δt₂₀ seconds after the transmission of the synchronization signal, in a step 102, the terminal 20 captures and receives the electromagnetic waves transmitted by the N wireless transmitters that are in its range. By way of illustration, the interval Δt₂₀ is equal to 0 seconds. Additionally, in this step, the transceiver 54 measures the power of each of the electromagnetic waves received, in order to obtain an indicator of the power of the received electromagnetic wave. Such an indicator is known by the acronym RSSI (“Received Signal Strength Indicator”) in the case of a WiFi network.

In a step 104, the transceiver 54 demodulates solely the received electromagnetic waves whose powers are above the threshold Pₘᵢₙ. In this step, the transceiver 54 also extracts from each of these received demodulated signals the characteristic data element Idᵢ of each wireless transmitter located in its range. Here, the characteristic data element Idᵢ comprises at least the MAC address of this wireless transmitter. Each of the characteristic data elements Idᵢ extracted is associated with the RSSI indicator obtained for the electromagnetic wave on the basis of which this data element Idᵢ has been extracted. It will be recalled that all the wireless transmitters have different MAC addresses, such that the characteristic data element Idᵢ makes it possible here to identify unambiguously the transmitter of the electromagnetic wave received among the set of wireless transmitters. The extracted characteristic data element Idᵢ may also comprise additional information such as the SSID label of the network and/or the name of the manufacturer of the wireless transmitter. The transceiver 54 then transmits each extracted data element Idᵢ and the RSSI indicator associated with it to the cryptoprocessor 56.

In a step 106, the cryptoprocessor 56 receives these extracted data elements Idᵢ and the associated RSSI indicators. At the end of this step, the cryptoprocessor 56 therefore has a list Le₂₀ comprising, for each wireless transmitter in its range, a line containing:
the characteristic data element Idᵢ of this wireless transmitter, and
the RSSI indicator of this wireless transmitter.

In a step 108, the cryptoprocessor 56 compares the number 120 of lines contained in the list Le₂₀ with a predetermined threshold Lₘₐₓ.

If the number 120 of lines is less than the threshold Lₘₐₓ, the cryptoprocessor 56 proceeds directly to a step 110. In the contrary case, it proceeds to a step 112.

In step 112, the cryptoprocessor 56 selects a limited number of lines in the list Le₂₀ to obtain a shortened list Le₂₀ᵣ containing only Lₘₐₓ lines. For this purpose, the cryptoprocessor 56 uses a first predetermined set of selection criteria. For example, this first set here comprises a single criterion which selects only the Lₘₐₓ lines containing the highest RSSI indicators. This selection criterion therefore results in the selection of only the Lₘₐₓ characteristic data elements Idᵢ extracted from the Lₘₐₓ most powerful electromagnetic waves received. The Lₘₐₓ most powerful electromagnetic waves received usually correspond to the Lₘₐₓ wireless transmitters closest to the terminal 20. The threshold Lₘₐₓ is usually less than 10 or 7. In the remainder of this description, Lₘₐₓ is equal to 9.

At the end of step 112, the list Le₂₀ᵣ replaces the list Le₂₀ and the method continues via step 110.

In step 110, the cryptoprocessor 56 constructs an intermediate key Kd_{i,20} for each characteristic data element Idᵢ contained in the list Le₂₀. The index “20” will be used subsequently to indicate that a data element, for example the key Kd_{i,20} in this case, has been constructed by the terminal 20. For this purpose, each key Kd_{i,20} is constructed on the basis of a single corresponding characteristic data element Idᵢ. The aim of this step is to make it difficult for any third party who knows the characteristic data elements Idᵢ to construct the intermediate keys Kd_{i,20}. Here, for this purpose, each intermediate key Kd_{i,20} is also constructed on the basis of secret information known only to the terminals 20 and 22. In this example, the secret information used is the key Kₘₐ and the vector VI. For example, each intermediate key Kd_{i,20} is constructed using the following relation: Kd_{i,20}=f_{ch}(VI XOR Idᵢ, Kₘₐ), where:
the symbol “XOR” denotes in this text the “exclusive OR” operation,
VI XOR Idᵢ is the result of the “exclusive OR” operation between the vector VI and the characteristic data element Idᵢ, and
f_{ch} is a prerecorded encryption function which encrypts the result VI XOR Idᵢ using the key Kₘₐ.

For example, the function f_{ch} is the AES (“Advanced Encryption Standard”) function.

Each constructed key Kd_{i,20} is associated with the RSSI indicator of the characteristic data element Idᵢ on the basis of which this key Kd_{i,20} has been constructed. For example, the key Kd_{i,20} is added to the corresponding line of the list Le₂₀.

In a step 114, the cryptoprocessor 56 determines a number Nₛ of common wireless transmitters which must also be detected by the terminal 22 for the terminals and 22 to be considered as being in the proximity of one another. Here, this number Nₛ is determined on the basis of the number 120 of lines in the list Le₂₀. It is therefore determined on the basis of the number of wireless transmitters in the range of the terminal 20. If appropriate, the determination of the number Nₛ may also allow for the ability of at least one of the terminals 20 and 22 to be a wireless transmitter without detecting itself as such to be taken into account. For example, the cryptoprocessor 56 uses for this purpose the following table T_{c}:

| | | Maximum number |
|---|---|---|
| | | of possible |
| I₂₀ | Nₛ | subsets (Kₘₐₓ) |
| 9 | 7 | 36 |
| 8 | 6 | 28 |
| 7 | 4 | 35 |
| 6 | 3 | 20 |
| 5 | 3 | 10 |
| 4 | 2 | 6 |
| 3 | 2 | 3 |
| 2 | 1 | 2 |
| 1 | 1 | 1 |

where:
the first column contains all the possible numbers of lines 120 for the table Le₂₀,
the second column contains the value of the number Nₛ associated with this number of lines,
the third column indicates the maximum number Kₘₐₓ of different subsets each containing Nₛ wireless transmitters that can be constructed when the list Le₂₀ contains I₂₀ lines. The subset (Kd_{1,20}, Kd_{2,20}, . . . Kd_{Ns,20}) is an example of a subset of the set of keys constructed in step 110, corresponding to such a subset of wireless transmitters. Specifically, here, each key Kd_{i,20} corresponds to a single respective wireless transmitter. A subset is different from another subset if it contains at least one key Kd_{i,20} that is not contained in the other subset.

In a step 116, the cryptoprocessor 56 then constructs, on the basis of the possible subsets, K corresponding encryption keys KS_{k,20}. More precisely, each key KS_{k,20} is constructed on the basis of each of the keys Kd_{i,20} of a single corresponding subset. For example, the key KS_{k,20} is constructed using the following relation: KS_{k,20}=Kd_{i1,20} XOR Kd_{i2,20} XOR . . . XOR Kd_{iNs,20}, where Kd_{iN,20} denotes a respective key Kd_{i,20} of the subset. In other words, the key KS_{k,20} is obtained by performing an “exclusive OR” between all the keys Kd_{ij,20} of the subset corresponding to this key KS_{k,20}. Given that there are Kₘₐₓ different subsets here, by the end of step 116 the cryptoprocessor 56 has constructed Kₘₐₓ different keys KS_{k,20}. In other words, in this embodiment, K is equal to Kₘₐₓ.

In a step 118, the cryptoprocessor 56 obtains the key KA₂₀ to be shared with the terminal 22. Here, for example, the cryptoprocessor 56 generates the key KA₂₀ by random or pseudo-random drawing.

In a step 120, the cryptoprocessor 56 encrypts the key KA₂₀ with each of the keys KS_{k,20} to obtain K different cryptograms KA*_{k,20}. For example, in this step, each cryptogram KA*_{k,20} is obtained by using the following relation: KA*_{k,20}=f_{ch}(KA₂₀, KS_{k,20}). The encryption function f_{ch} is, for example, the same as that described above.

In a step 122, the cryptoprocessor 56 constructs a digital fingerprint KA₂₀-Check of the key KA₂₀, using a hash function, that is to say using what is called a one-way function, in other words one that is non-reversible for practical purposes. For example, the fingerprint KA₂₀-Check is constructed using the following relation: KA₂₀-Check=f_{H}(KA₂₀), where f_{H} is a hash function. For example, the function f_{H} is the function known by the name SHA256.

In a step 124, the terminal 20 transmits a “challenge” message to the terminal 22. This message contains, notably:
the number Nₛ determined in step 114,
the fingerprint KA₂₀-Check constructed in step 122,
the K cryptograms KA*_{k,20} obtained in step 120.

This message is, for example, transmitted to the terminal 22 via the network 24.

In response to the synchronization signal, the terminal 22 launches, Δt₂₂ seconds after the reception of this signal, the execution of steps 132 to 144. The period Δt₂₂ is chosen so that steps 132 and 134 are executed at the same time, or practically at the same time, as steps 102 and 104. For example, for this purpose, here, the period Δt₂₂ is chosen to be equal to the period Δt₂₀. Steps 132 to 144 are identical, respectively, to steps 102 to 114, except in that they are executed by the terminal 22. In particular, the first set of selection criteria used in step 142 is the same as that used in step 112. However, as shown in FIGS. 1 and 2, the terminal 22 is not necessarily situated at the same location as the terminal 20. In these conditions, the characteristic data elements Idᵢ extracted in step 134 are not necessarily the same as those extracted by the terminal 20. Thus, the list Le₂₀ constructed by the terminal 22 does not necessarily contain the same number of lines and/or the same extracted characteristic data elements and/or the same RSSI labels. To distinguish the list Le₂₀ of the terminal 22 from that of the terminal 20, the list Le₂₀ of the terminal 22 will subsequently be denoted “Le₂₂”. The number of intermediate keys Kd_{i,20} constructed and the intermediate keys Kd_{i,20} constructed by the terminal 22 in step 144 are not necessarily identical to those of the terminal 20. Subsequently, to distinguish the keys Kd_{i,20} constructed by the terminal 22 from those constructed by the terminal 20, the intermediate keys constructed in step 144 are denoted “Kd_{i,22}” in place of “Kd_{i,20}”. Similarly, the number of intermediate keys constructed in step 144 is denoted 122 in place of 120. Also because of these differences, the number of keys KS_{k,20} and the keys KS_{k,20} that may be constructed by the terminal 22 are not necessarily the same as in the case of the terminal 20. Subsequently, in order to distinguish them, the keys KS_{k,20} constructed by the terminal 22 are denoted KS_{m,22}. The number of keys KS_{m,22} constructed by the terminal 22 is denoted “M” in place of “K”.

In a step 150, the terminal 22 receives the challenge message.

In response to the reception of this challenge message, in a step 152, the cryptoprocessor of the terminal 22 decrypts each of the cryptograms KA*_{k,20} contained in this message. More precisely, as long as a received cryptogram KA*_{k,20} has not been correctly decrypted, the cryptoprocessor of the terminal 22 reiterates operations 154 to 160 in a loop. Before proceeding to the reiteration of operations 154 to 160, the cryptoprocessor of the terminal 22 selects a cryptogram KA*_{k,20} from among the K cryptograms KA*_{k,20} received in step 150.

In operation 154, the cryptoprocessor of the terminal 22 constructs a new key KS_{m,22} which has not already been used to attempt to decrypt the cryptogram KA*_{k,20}. To construct the key KS_{m,22}, the cryptoprocessor of the terminal 22 proceeds in exactly the same way as that described with reference to step 116. Thus, in operation 154, each key KS_{m,22} is constructed using the following relation: KS_{m,22}=Kd_{i1,22} XOR Kd_{i2,22} XOR . . . XOR Kd_{iNs,22}, where Kd_{ij,22} denotes a respective key Kd_{i,22} of the subset. The number Nₛ used to construct the keys KS_{m,22} is that which was received in step 150. The keys Kd_{i,22} used are those constructed in step 144.

Given that the list Le₂₂ does not necessarily contain the same characteristic data elements as the list Le₂₀, the keys KS_{m,22} constructed by the terminal 22 are not necessarily the same as the keys KS_{k,20} constructed by the terminal 20. However, if the terminal 22 is sufficiently in the proximity of the terminal 20, as for example in the situation shown in FIG. 1, the lists Le₂₀ and Le₂₂ each comprise at least Nₛ identical characteristic data elements Idᵢ. In this case, at least one of the keys KS_{m,22} constructed by the terminal 22 is identical to one of the keys KS_{k,20} constructed by the terminal 20. The terminal 22 is therefore capable, in this case only, of correctly decrypting one of the received cryptograms KA*_{k,20} and thus obtaining the key KA₂₀ shared with the terminal 20.

Conversely, if the terminals 20 and 22 are sufficiently distant from one another, as in the situation shown in FIG. 2, the lists Le₂₀ and Le₂₂ each comprise less than Nₛ identical characteristic data elements. Therefore, none of the keys KS_{m,22} constructed by the terminal 22 is identical to one of the keys KS_{k,20} constructed by the terminal 20. In this situation, none of the keys KS_{m,22} makes it possible to correctly decrypt one of the K cryptograms KA*_{k,20} received. Therefore, the terminal 22 cannot obtain the key KA₂₀ if it is distant from the terminal 20.

In operation 156, the cryptoprocessor of the terminal 22 decrypts the selected cryptogram KA*_{k,20} with the key KS_{m,22} constructed in operation 154. At the end of operation 156 it obtains a key KA₂₂. For example, this operation is performed using the following relation: KA₂₂=f_{ch}⁻¹(KA*_{k,20}, KS_{m,22}). The decryption function f_{ch}⁻¹ is the inverse of the function f_{ch} described above.

In operation 158, the cryptoprocessor of the terminal 22 constructs the digital fingerprint KA₂₂-Check of the key KA₂₂ obtained at the end of operation 156. For this purpose, the same hash function f_{H} as that used in step 122 is used. Here, the fingerprint KA₂₂-Check is therefore constructed according to the following relation: KA₂₂-Check=f_{H}(KA₂₂).

In operation 160, the cryptoprocessor of the terminal 22 compares the fingerprint KA₂₂-Check constructed in operation 158 with the fingerprint KA₂₀-Check received in step 150.

If the fingerprints KA₂₂-Check and KA₂₀-Check are different, this means that the cryptogram KA*_{k,20} has not been decrypted correctly. This is typically what happens when the key KS_{m,22} used to decrypt the cryptogram KA*_{k,20} is different from the key KS_{k,20} used to obtain this cryptogram. In this case, the method returns to operation 154. The subsequent reiteration of operations 154 to 160 is executed with a new key KS_{m,22}, constructed in the new execution of operation 154, which has not already been used to decrypt the selected cryptogram KA*_{k,20}.

If all the keys KS_{m,22} have already been used unsuccessfully in an attempt to correctly decrypt the currently selected cryptogram KA*_{k,20}, then, in a step 162, the cryptoprocessor of the terminal 22 selects, from among the K cryptograms KA*_{k,20} received in step 150, a new cryptogram KA*_{k,20} which has not been selected already. Operations 154 to 160 are then reiterated for this new selected cryptogram KA*_{k,20}.

In step 162, if the K cryptograms KA*_{k,20} received in step 150 have all been selected already, then the method stops. In this case, the key KA₂₀ is not shared between the terminals 20 and 22. This is because the terminal 22 has not succeeded in correctly decrypting any of the cryptograms KA*_{k,20} received in step 150, and therefore has not succeeded in obtaining the key KA₂₀. This is due to the fact that these two terminals 20 and 22 are not in the proximity of one another.

If, in operation 160, the cryptoprocessor of the terminal 22 determines that the fingerprints KA₂₀-Check and KA₂₂-Check are identical, the cryptogram KA*_{k,20} has been correctly decrypted. In this case, the key KA₂₂ obtained at the end of step 156 is identical to the key KA₂₀. The method then continues via an operation 164.

In operation 164, the cryptoprocessor of the terminal 22 stores the key KA₂₂ as being the key shared with the terminal 20. Additionally, here, in operation 164, the terminal 22 sends a message to the terminal 20 to indicate that it now also has the key KA₂₀.

The method then continues via a phase 170 of secure data exchange. For example, in phase 170, the terminals 20 and 22 establish a secure data exchange link between them. For this purpose, the cryptoprocessor 56 encrypts with the key KA₂₀ the data transmitted to the terminal 22, via the network 24 for example, and the terminal 22 decrypts these received data with its key KA₂₂. In this phase 170, in a reciprocal manner, the data transmitted from the terminal 22 to the terminal 20 are encrypted with the key KA₂₂ and the cryptoprocessor 56 decrypts these data with the aid of the key KA₂₀.

Preferably, steps 100 to 152 are reiterated at regular intervals to ensure that the terminal 22 is still in the proximity of the terminal 20. For example, the regular interval is less than 24 hours or 4 hours or 1 hour or 30 minutes.

FIG. 5 shows a method identical to the method of FIG. 4, except in that steps 116 and 152 are replaced by steps 166 and 172, respectively. To simplify FIG. 5, only steps 166 and 172 have been shown. The broken lines in FIGS. 5 to 7 indicate that the other steps of the method have not been shown.

Step 166 is identical to step 116, except in that the cryptoprocessor 56 selects a number K of subsets strictly below the maximum number Kₘₐₓ of possible subsets. For this purpose, the cryptoprocessor 56 uses a second predetermined set of selection criteria.

For example, here, this second set comprises a single selection criterion which requires each of the K selected subsets to comprise:
Nₕ keys Kd_{i,20} associated with an RSSI indicator above a first predetermined threshold Pₕ, and
Nₛ-Nₕ keys Kd_{i,20} associated with an RSSI indicator below a second threshold Pr.
   The threshold P_{f} is less than or equal to the threshold Pₕ. For example, here, the thresholds Pₕ and P_{f} are equal to −50 dBm. Thus, each of the K subsets selected to construct a key KS_{k,20} comprises:
Nₕ keys Kd_{i,20} obtained from characteristic data elements Idᵢ extracted from received electromagnetic waves having a high power, that is to say a power of more than Pₕ, and
Nₛ-Nₕ keys Kd_{i,20} obtained from characteristic data elements Idᵢ extracted from electromagnetic waves having a low power, that is to say a power of less than Pr.

For example, Nₕ is a constant which is predetermined, or preferably determined on the basis of the number of lines 20 in the list Le₂₀.

Thus, each of the K keys KS_{k,20} is constructed using the following relation: KS_{k,20}=Ks₁ XOR Ks₂ XOR . . . XOR Ks_{Ns-Nh} XOR Kh₁ XOR . . . XOR Kh_{Nh}, where:
Ksᵢ is a key Kd_{i,20} obtained from a characteristic data element Idᵢ extracted from received electromagnetic waves whose power is below the threshold P_{f}, and
Khᵢ is a key Kd_{i,20} obtained from characteristic data elements Idᵢ extracted from received electromagnetic waves having a power greater than or equal to the threshold Pₕ.

The terminal 20 transmits the number Nₕ to the terminal 22, in step 124 for example. For example, the number Nₕ is contained in the challenge message.

Step 172 is identical to step 152, except in that operation 154 is replaced by an operation 178.

In operation 178, the cryptoprocessor of the terminal 22 uses the same second set of selection criteria to select the subsets from which it constructs the keys KS_{m,22}.

FIG. 6 shows a method identical to the method of FIG. 4 except in that step 110 is replaced by a step 190. Similarly, step 140 is replaced by a step 192.

In step 190, each key Kd_{i,20} is also constructed on the basis of a data element which varies whenever step 110 is executed. Thus, even if the characteristic data elements Idᵢ extracted are the same, each new execution of step 190 results in the construction of different keys Kd_{i,20}. For example, in step 190 a new vector VI is drawn randomly or pseudo-randomly for this purpose, and this new vector VI is then transmitted to the terminal 22. For example, the new vector VI is incorporated in the challenge message transmitted to the terminal 22. Step 192 is executed only after the new vector VI has been received. Step 192 is identical to step 140 except in that it uses the new vector VI received to construct each of the keys Kd_{i,22}.

Consequently, on each new execution of step 116, the constructed keys KS_{k,20} are different from those constructed during the preceding executions of step 116. Therefore, it is no longer possible to try to exploit the fact that the keys KS_{k,20} remain unchanged on each iteration of steps 102 to 116 in order to obtain the key KA₂₀ when the terminals 20 and 22 are not in the proximity of one another. In fact, if the keys KS_{k,20} remain unchanged as long as their electromagnetic environment remains unchanged, a pirate terminal may try to record the keys KS_{m,22} constructed during a preceding iteration of step 152. Then, for the subsequent executions of step 152, instead of constructing the keys KS_{m,22} on the basis of the characteristic data elements extracted from the current electromagnetic environment of this pirate terminal, it uses the recorded keys KS_{m,22} in order to decrypt the received cryptograms KA*_{k,20}. Such a fraud, although very difficult to carry out, would enable the pirate terminal to establish the shared key KA₂₂ even if this terminal has been moved away from the terminal 20, provided that the wireless transmitters in the range of the terminal 20 remain unchanged.

FIG. 7 shows a method identical to the method of FIG. 5 except in that step 166 is replaced by a step 200 and a step 202 is inserted between steps 150 and 172. In this embodiment, the second sets of selection criteria prerecorded in the terminals and 22 are identical, and each comprise a plurality of possible selection criteria.

In step 200, a number Nₐ is drawn randomly or pseudo-randomly. Then, also in this step 200, this number Nₐ is used in order to choose, from the second set of selection criteria, the criterion that will be used to select the subsets used for constructing the keys KS_{k,20}. This number Nₐ is also transmitted to the terminal 22 before the execution of step 172 begins.

Then, on the basis of the received number Nₐ, and applying the same choice algorithm as that used by the terminal 20, in step 202 the terminal 22 chooses a selection criterion from the second set of selection criteria. This selection criterion is then used in operation 178 for selecting the subsets used for constructing the keys KS_{m,22}. Given that the terminal 22 uses the same number Nₐ and the same choice algorithm, it chooses the same selection criterion as that used by the terminal 20. As in the method of FIG. 6, this enables the keys KS_{k,20} to be varied even if the electromagnetic environment of the terminal 20 remains unchanged in each reiteration of step 200.

### CHAPTER II: VARIANTS

In the set of variants described here, those skilled in the art will understand that, when modifications of the method executed by the master terminal are proposed, corresponding modifications must usually be made on the slave terminal. Thus, in the remainder of this chapter, only the modifications of either the master terminal or the slave terminal are described.

### Chapter II.1: Variants of the Encryption Operations

There are numerous encryption and decryption functions that can be used in the embodiments described here. For example, in a simplified embodiment, the encryption function is simply an “exclusive OR” between the key KA₂₀ and the characteristic data elements Idᵢ extracted, or the keys Kd_{i,20} or the key KS_{k,20}.

Numerous methods are possible for generating the key KS_{k,20} on the basis of the characteristic data elements Idᵢ extracted. For example, in a simplified embodiment, each key KS_{k,20} is constructed using the following relation: KS_{k,20}=Idᵢ₁ XOR Idᵢ₂ XOR . . . XOR Id_{iNs}. In this case, the intermediate keys Kd_{i,20} are not used, and the key Kₘₐ and the vector VI may be omitted. In another variant, the key KS_{k,20} is constructed using the following relation: KS_{k,20}=f_{ch}(Idᵢ₁ XOR Idᵢ₂ XOR . . . XOR Id_{iNs} Kₘₐ). In this case, the steps of constructing the intermediate keys Kd_{i,20} may be omitted.

The key Kₘₐ may be common to all the terminals.

The intermediate key Kd_{i,20} may be constructed differently. For example, the key Kd_{i,20} may also be constructed using the following relation: Kd_{i,20}=f_{ch}(Kₘₐ; VI XOR Idᵢ). In this case, it is the key Kₘₐ that is encrypted, using the result of the operation VI XOR Idᵢ as the key. Evidently, there are numerous other possibilities for obtaining the key Kd_{i,20} on the basis of the characteristic data element Idᵢ and a secret piece of information. For example, the use of the vector VI may be omitted.

In all the embodiments, the XOR operation may be replaced by any commutative operation, such as the NAND operation.

Step 110 may be omitted. In this case, the keys KS_{k,20} are directly constructed on the basis of the characteristic data elements Idᵢ without using a secret piece of information such as the key Kₘₐ or the vector VI.

In a variant, the key KA₂₀ is obtained in a different way. For example, instead of being generated by random or pseudo-random drawing, it is prerecorded in a non-volatile memory of the first terminal. Consequently, obtaining the key KA₂₀ is simply a matter of reading the key KA₂₀ from this non-volatile memory. In another variant, the key KA₂₀ is generated on the basis of the characteristic data elements Idᵢ extracted. In fact, the methods described here for sharing the key KA₂₀ are applicable regardless of the method of obtaining the key KA₂₀.

Variants of the Sets of Selection Criteria:

Other embodiments of the first set of selection criteria are possible. The first set may comprise other selection criteria in addition to, or in place of, the selection criterion based on the RSSI indicator. For example, in a variant, it comprises a selection criterion that excludes from the list Le₂₀ᵣ all the wireless transmitters manufactured by a particular manufacturer. In another example, it comprises a selection criterion such that the terminal preferentially selects the characteristic data elements Idᵢ of wireless transmitters whose manufacturers belong to a prerecorded list of known manufacturers. Similarly, a plurality of different selection criteria may be combined. In the last-mentioned case, the different selection criteria may be weighted with respect to one other, using weighting coefficients.

The first set may also comprise a selection criterion that automatically eliminates each characteristic data element Idᵢ extracted from a received electromagnetic wave whose power is below a predetermined threshold Pr. For example, the threshold P_{f} is equal to −70 dBm.

When the selection criterion of the second set is used, for selecting the Nₛ-Nₕ keys Kd_{i,20}, the selection criterion may be that of selecting the Nₛ-Nₕ keys Kd_{i,20} constructed on the basis of characteristic data elements Idᵢ extracted from received electromagnetic waves having a power in the range [Pₘ; Pₕ[, where Pₘ is a predetermined threshold that is strictly less than Pₕ. For selecting the Nₕ keys Kd_{i,20}, the selection criterion may be that of selecting these Nₕ keys Kd_{i,20} from a subset containing solely the Nₕ keys Kd_{i,20} associated with the Nₕ largest MAC addresses. Nₕ is strictly less than Nₛ and is preferably greater than two. This selection criterion is a first example of a selection criterion that does not depend on the power of the received electromagnetic waves. More generally, any other method capable of leading, in a deterministic way, to the same selection of keys Kd_{i,20} by the terminals 20 and 22 when these terminals 20 and 22 are situated in the same location is acceptable.

In a variant, the number Nₕ is a constant prerecorded in each terminal, for example during manufacture. In this case, the number Nₕ does not need to be transmitted to the terminal 22.

In other variants, the selection criteria for the second set do not take into account the power of the received electromagnetic waves. For example, the keys Kd_{i,20} are classified in increasing or decreasing order of MAC addresses, and only the subsets containing only keys Kd_{i,20} belonging to the first half of this classification are selected. The keys Kd_{i,20} may also be classified in increasing or decreasing order of a digital fingerprint f_{H}(@MAC) instead of using their MAC address directly, where @MACᵢ is the MAC address associated with the key Kd_{i,20}. In another variant, after having been classified in increasing or decreasing order of MAC addresses or RSSI indicator, only the subsets containing only keys Kd_{i,20} of even or odd rank in this classification are selected.

The second set of selection criteria may additionally or alternatively comprise selection criteria other than those described above. For example, instead of comprising a selection criterion that selects only the subsets that have Nₕ keys Kd_{i,20} obtained on the basis of characteristic data elements Idᵢ extracted from high-power electromagnetic waves, the second set comprises a selection criterion that selects only the subsets in which:
Nₛₕ keys Kd_{i,20} are obtained from characteristic data elements Idᵢ extracted from electromagnetic waves having a power of more than −50 dBm;
N_{sb} keys Kd_{i,20} are obtained from characteristic data elements Idᵢ extracted from electromagnetic waves having a power of between −60 dBm and −50 dBm;
Nₛₘ keys Kd_{i,20} are obtained from characteristic data elements Idᵢ extracted from electromagnetic waves having a power of between −70 dBm and −60 dBm, and
N_{sf} keys Kd_{i,20} are obtained from characteristic data elements Idᵢ extracted from electromagnetic waves having a power of less than −70 dBm.

Variants of the Determination of the Number Nₛ:

The number Nₛ may be determined differently. For example, in a simplified embodiment, Nₛ is a constant equal to one.

In variants, the terminal 20 does not transmit the number Nₛ to the terminal 22. In this case, the terminal 22 must also successively try out the different possible values of the number Nₛ. This causes the terminal 22 to construct keys KS_{m,22} successively on the basis of a single key Kd_{i,22}, then of two keys Kd_{i,22}, then of three keys Kd_{i,22}, up to a predetermined threshold Nₛₘₐₓ for the number Nₛ.

In another variant, the number Nₛ is a constant. For example, the number Nₛ may be recorded in all the terminals at the time of manufacture. In this embodiment, it is not necessary to transmit the number Nₛ to the terminal 22 in step 124. This embodiment may be used, notably, in the case where the number of wireless transmitters in the environment of each of the terminals is a constant known in advance.

Other Variants:

Step 100 may be omitted. In this case, the launch of steps 102, 104 and 132, 134 takes place asynchronously, that is to say without the launches being temporally synchronized with one another.

In another variant, it is the challenge message that also acts as a synchronization signal. In this case, steps 132 to 144 are launched solely in response to the reception of the challenge message.

The above method may also be used to share a key among more than two terminals. For this purpose, the terminal 20 transmits the challenge message to a third terminal, in addition to the terminal 22. This third terminal then executes the same operations and the same steps as the terminal 22 for establishing the key KA₂₀ shared with the terminals 20 and 22.

The embodiments described here may easily be adapted to make use of the presence, in the proximity of the terminals, of wireless transmitters other than those of a WiFi network. For example, the description given here is applicable to Bluetooth or LoRa networks or any other support network of the IoT (for “Internet of Things”). In particular, the same set may comprise wireless transmitters compatible with different standards. For example, there may be both WiFi transmitters and Bluetooth transmitters in the same set of wireless transmitters. In this case, the terminals are equipped with both a WiFi transceiver and a Bluetooth transceiver so that some of the keys Kd_{i,20} are constructed on the basis of characteristic data elements of WiFi transmitters and other keys Kd_{i,20} are constructed on the basis of characteristic data elements of Bluetooth transmitters. Thus, in this embodiment the simultaneous presence of a plurality of wireless transmitters conforming to different standards is exploited to ensure the proximity of the terminals.

In a variant, in response to the reception of the challenge message, the terminal 22 launches a timer which counts down a period D1. When the period D1 has expired, the cryptoprocessor of the terminal 22 automatically interrupts the execution of step 152, even if the shared key KA₂₂ has not yet been obtained. Preferably, the period D1 is initialized on the basis of the number Nₛ.

The keys KS_{k,20} may also be constructed by taking other local information into account. For example, in the case where the terminals 20 and 22 are also connected to the same local wired network, the terminals 20 and 22 detect the MAC addresses of all the devices connected to this local wired network. The terminal 20 then generates each key KS_{k,20} by additionally taking into account, for example, the detected MAC addresses. For example, for this purpose the cryptoprocessor adds the detected MAC addresses to one another. It then combines the sum thus obtained with each of the constructed keys KS_{k,20}, using an “exclusive OR” operation for example, to obtain a new key KS_{k,20} which is then used in place of the preceding key KS_{k,20}. Consequently, the terminal 22 cannot correctly decrypt the cryptogram KA*_{k,20} unless it is also connected to the same wired network as the terminal 20.

A wireless transmitter may be a repeater of wireless signals transmitted by another source wireless transmitter. In this case, the signals transmitted by the repeater comprise the same SSID label as those transmitted by the source wireless transmitter. On the other hand, the MAC address of the repeater is different from that of the source wireless transmitter.

In a variant, the cryptoprocessor 56 is omitted. In this case, the set of steps is executed by the microprocessor 50.

In a variant, the terminal 20 is configured solely for acting as a master terminal and the terminal 22 is configured solely for acting as a slave terminal. Thus, in this embodiment, the roles of the terminals 20 and 22 cannot be reversed.

In a variant, the terminals 20 and 22 communicate with one another by means of the wireless transmitters. In this case, the network 24 is the WiFi network supported by the signal transmitted by one of the wireless transmitters which is also in the range of the terminals 20 and 22. In another variant, the network 24 is a WiFi network supported by a signal transmitted by one of the terminals 20, 22.

The sensitivities of all the terminals are not necessarily identical. For example, in a variant, the thresholds Pₘᵢₙ of the terminals 20 and 22 are different. In this case, the sensitivity threshold of the terminal 20 is denoted Pₘᵢₙ₂₀ and the sensitivity threshold of the terminal 22 is denoted Pₘᵢₙ₂₂.

The threshold Lₘₐₓ used by the terminal 22 may be different from the threshold Lₘₐₓ used by the terminal 20. In this case, the thresholds Lₘₐₓ of the terminals 20 and 22 are denoted, respectively, Lₘₐₓ₁ and Lₘₐₓ₂.

Characteristic data elements other than the MAC address of the wireless transmitters may be used to implement the methods described here. For example, in a variant, the characteristic data element comprises not the MAC address, but the network identifier known by the acronym SSID and/or the name of the manufacturer of the wireless transmitter. The characteristic data element may also be a combination of a plurality of characteristic data elements extracted from the electromagnetic waves received.

Preferably, the number K is less than the number N. However, in the embodiments where Nₛ is greater than two or three, the number K may be greater than the number N.

### CHAPTER III: ADVANTAGES OF THE EMBODIMENTS DESCRIBED HERE

In the methods described here, the terminals 20 and 22 cannot succeed in establishing a shared cryptographic key unless these terminals are in the proximity of one another. This is because, if they are distant from one another, the wireless transmitters located in the range of the terminal 20 are then different from those located in the range of the terminal 22. In these conditions, the characteristic data elements Idᵢ extracted from the electromagnetic waves transmitted by the wireless transmitters in the range of the terminal 20 are not the same as those extracted by the terminal 22. In this case, the terminal 22 cannot construct a key KS_{m,22} identical to one of the keys KS_{k,20} constructed by the terminal 20. Therefore, the terminal 22 cannot correctly decrypt the cryptogram KA*_{k,20} received, and consequently cannot obtain the shared key KA₂₀.

This method also has numerous other advantages. In particular, this method is reliable, because in order to determine the proximity of the terminals:
it is not necessary to measure the propagation time of the signals exchanged between these terminals,
it is not necessary to make use of a parameter of the data frames exchanged between the terminals representative of the number of nodes passing through this data frame before reaching the other terminal. Such a parameter is commonly known by the term “time to live” in the IP protocol,
it is not necessary to make use of the IP address assigned to the terminals.

The propagation time, the parameters of the data frames exchanged between the terminals, and the IP addresses of these terminals are elements that can easily be modified to give the impression that these terminals are in the proximity of one another.

The methods described also make it possible to establish a cryptographic key shared among more than two terminals. Furthermore, it is not necessary for a communication channel to be established between the two terminals before the shared key is generated.

The fact of synchronizing the extraction by the terminals of the data elements Idᵢ enables the method to be made less sensitive to the addition or removal of wireless transmitters.

The use of the MAC address as the characteristic data element increases the reliability of the method, because the MAC address of a wireless transmitter is difficult to modify, and in any case is more difficult to modify than an SSID label.

Limiting the number of characteristic data elements Idᵢ used enables the execution of the subsequent steps to be accelerated.

Limiting the number of keys KS_{k,20} on the basis of a selection criterion taking into account the power of the electromagnetic waves received makes it possible to limit even further the maximum distance Dₘₐₓ that can separate two terminals while still allowing them to be considered as being in the proximity of one another. This is because, in this case, it is not only necessary for the terminals 20 and 22 to detect the same wireless transmitters, but the power of the electromagnetic waves received from these wireless transmitters must also be similar.

The fact that the cryptogram KA*_{k,20} is constructed solely on the basis of a combination of a plurality of extracted characteristic data elements means that, in order to establish the shared key, the terminal 22 must also be in the proximity of these Nₛ wireless transmitters. This reduces the maximum distance Dₘₐₓ. This also makes it more difficult to mount attacks in the form of attempts to reproduce the environment of the terminal 20 around the terminal 22.

Requiring the use of Nₕ characteristic data elements Idᵢ extracted from electromagnetic waves having a power greater than Pₕ, and Nₛ-Nₕ characteristic data elements extracted from electromagnetic waves having a power of less than P_{f}, further decreases the distance Dₘₐₓ. This also decreases the number of keys KS_{k,20}, thereby accelerating the execution of the method.

By choosing the selection criteria of the first or second set on the basis of a random or pseudo-random number, it is possible to renew the keys KS_{k,20} even if the wireless transmitters in the environment of the terminal 20 remain unchanged.

1. A method of establishing a cryptographic key KA₂₀ shared between a first and a second terminal, the establishment being conditional on the fact that these two terminals are in the proximity of one another, wherein:
each wireless transmitter, of a set of wireless transmitters comprising at least one wireless transmitter, transmits electromagnetic waves that are modulated, at least at each instant, on the basis of a characteristic data element of this wireless transmitter or of the wireless network to which it belongs, a characteristic data element of a wireless transmitter being a data element which makes it possible to identify unambiguously this wireless transmitter which transmits the electromagnetic waves among the set of the wireless transmitters of said set, and a characteristic data element of a wireless network being a data element which makes it possible to identify unambiguously the wireless network to which the wireless transmitter transmitting the electromagnetic waves belongs, wherein:
the first terminal executes the following steps:
a1) it receives the electromagnetic waves transmitted by the N wireless transmitters whose powers, at this first terminal, are above a first predetermined threshold Pₘᵢₙ₁ of detectability, N being a first natural number greater than or equal to one,
b1) it extracts, by demodulation of the received electromagnetic waves, only the characteristic data elements transmitted by each of these N wireless transmitters,
c1) it constructs an encryption key KS_{k,20} on the basis of at least one characteristic data element extracted in step b1), then
d1) it encrypts the key KA₂₀ using the constructed encryption key KS_{k,20}, steps c1) and d1) being reiterated for K distinct extracted characteristic data elements so as to obtain K different cryptograms KA*_{k,20}, where K is a second natural number greater than or equal to one,
e1) it constructs a digital fingerprint KA₂₀-Check of the key KA₂₀, using a hash function,
f1) it transmits to the second terminal each of the K cryptograms KA*_{k,20} and the digital fingerprint KA₂₀-Check,
the second terminal executes the following steps:
a2) it receives the electromagnetic waves transmitted by the J wireless transmitters whose powers, at this second terminal, are above a second predetermined threshold Pₘᵢₙ₂ of detectability, J being a third natural number greater than or equal to one,
b2) it extracts, by demodulation of the received electromagnetic waves, only the characteristic data elements transmitted by each of these J wireless transmitters,
c2) it constructs M different keys KS_{m,22}, proceeding for each key KS_{m,22} in the same way as in step c1), but using the characteristic data elements extracted in step b2) in place of the characteristic data elements extracted in step b1), where M is a fourth natural number greater than or equal to one,
d2) it receives the K cryptograms KA*_{k,20} and the digital fingerprint KA₂₀-Check transmitted by the first terminal,
e2) as long as at least one of the cryptograms KA*_{k,20} received has not been correctly decrypted, it successively reiterates the following steps, selecting on each occasion a new cryptogram chosen from the group consisting of the K cryptograms KA*_{k,20} received:
d2-1) it decrypts the selected cryptogram using one of the constructed keys KS_{m,22}, and thus obtains a key KA₂₂,
d2-2) it constructs a digital fingerprint KA₂₂-Check of this key KA₂₂, using the same hash function as that used in step e1),
d2-3) it compares this constructed fingerprint KA₂₂-Check with the fingerprint KA₂₀-Check received,
d2-4) if the digital fingerprints KA₂₀-Check and KA₂₂-Check are different, it returns to step d2-1) to re-execute steps d2-1) to d2-3), using a new key KS_{m,22}, and
d2-5) only if the digital fingerprints KA₂₀-Check and KA₂₂-Check are identical, the cryptogram KA*_{k,20} has been correctly decrypted, and it stores the key KA₂₂ as being the key identical to the key KA₂₀ which is now shared with the first terminal, this key KA₂₂ being usable to decrypt and encrypt the data exchanges between these two terminals.

2. The method as claimed in claim 1, wherein:
one of the first and second terminals transmits a synchronization signal to the other of the first and second terminals, then
in response to the transmission of this synchronization signal, the first terminal launches the execution of steps a1) and b1), and the second terminal launches the execution of steps a2) and b2).

3. The method as claimed in claim 1, wherein each extracted characteristic data element comprises at least the MAC (“Media Access Control”) address of the wireless transmitter of the electromagnetic waves received.

4. The method as claimed claim 1, wherein:
after step b1) and before step c), the first terminal compares the number of characteristic data elements extracted with a predetermined threshold Lₘₐₓ₁ and, only if the number of characteristic data elements extracted is greater than this threshold Lₘₐₓ₁, the first terminal selects Lₘₐₓ₁ characteristic data elements from among the set of the characteristic data elements extracted in step b1) on the basis of a first predetermined set of selection criteria, and then only the characteristic data elements selected in this way are used in the subsequent steps by the first terminal,
after step b2) and before step c2), the second terminal compares the number of characteristic data elements extracted with a predetermined threshold Lₘₐₓ₂ and, only if the number of characteristic data elements extracted is greater than this threshold Lₘₐₓ₂, the second terminal selects Lₘₐₓ₂ extracted characteristic data elements from among the set of the characteristic data elements extracted in step b2) on the basis of the same first predetermined set of selection criteria.

5. The method as claimed in claim 4, wherein the first set comprises a selection criterion that selects only the characteristic data elements extracted from the most powerful electromagnetic waves received.

6. The method as claimed in claim 1, wherein, in step c1), each key KS_{k,20} is constructed on the basis of each of the characteristic data elements of a respective subset of at least Nₛ different characteristic data elements extracted in step b1), the subsets used for constructing the K keys KS_{k,20} differing from one another in the characteristic data elements that they contain, where Nₛ is a predetermined minimum number of characteristic data elements that must be common to the first and second terminals for them to be considered as being in the proximity of one another, the number Nₛ being greater than or equal to two.

7. The method as claimed in claim 6, wherein, in step c1), among the totality of the possible subsets of Nₛ keys, the first terminal selects only K of these on the basis of a second predetermined set of selection criteria.

8. The method as claimed in claim 7, wherein the second set of selection criteria comprises a predetermined selection criterion which selects only the subsets that contain a predetermined number Nₕ of characteristic data elements extracted from received electromagnetic waves whose power is above a first predetermined threshold Pₕ and Nₛ-Nₕ characteristic data elements extracted from received electromagnetic waves whose powers are below a second threshold P_{f}, where Nₕ is less than Nₛ and the second threshold P_{f} is less than or equal to the threshold Pₕ.

9. The method as claimed in claim 6, wherein, in step c1), the first terminal determines the number Nₛ on the basis of the number of characteristic data elements extracted in step b1).

10. The method as claimed in claim 1, wherein:
the first terminal draws a random or pseudo-random number, then
the first terminal chooses, from among the prerecorded sets of a plurality of first or a plurality of second selection criteria, a first or a second selection criterion to be used on the basis of this random or pseudo-random number drawn, and
the first terminal transmits this random or pseudo-random number drawn to the second terminal, and
in response, the second terminal chooses, from the same prerecorded set of a plurality of first or second sets of selection criteria, and in the same manner as the first terminal, the first or second selection criterion to be used on the basis of the random or pseudo-random number received.

11. The method as claimed in claim 1, wherein, in step c1), the first terminal constructs each encryption key KS_{k,20} on the basis, additionally, of a secret piece of information known to the second terminal and unknown to a third terminal, this third terminal also being capable of executing steps a2) to e2).

12. A method for the execution by the first terminal of the steps required for implementing a method as claimed in claim 1, wherein the first terminal executes the following steps:
a1) it receives the electromagnetic waves transmitted by the N wireless transmitters whose powers, at this first terminal, are above a first predetermined threshold Pₘᵢₙ₁ of detectability, N being a first natural number greater than or equal to one,
b1) it extracts, by demodulation of the received electromagnetic waves, only the characteristic data elements transmitted by each of these N wireless transmitters,
c1) it constructs an encryption key KS_{k,20} on the basis of at least one characteristic data element extracted in step b1), then
d1) it encrypts the key KA₂₀ using the constructed encryption key KS_{k,20}, steps c) and d1) being reiterated for K distinct extracted characteristic data elements so as to obtain K different cryptograms KA*_{k,20}, where K is a second natural number greater than or equal to one,
e1) it constructs a digital fingerprint KA₂₀-Check of the key KA₂₀, using a hash function,
f1) it transmits to the second terminal each of the K cryptograms KA*_{k,20} and the digital fingerprint KA₂₀-Check.

13. A method for the execution by the second terminal of the steps required for implementing a method as claimed in claim 1, wherein the second terminal executes the following steps:
a2) it receives the electromagnetic waves transmitted by the J wireless transmitters whose powers, at this second terminal, are above a second predetermined threshold Pₘᵢₙ₂ of detectability, J being a third natural number greater than or equal to one,
b2) it extracts, by demodulation of the received electromagnetic waves, only the characteristic data elements transmitted by each of these J wireless transmitters,
c2) it constructs M different keys KS_{m,22}, proceeding for each key KS_{m,22} in the same way as in step c1), but using the characteristic data elements extracted in step b2) in place of the characteristic data elements extracted in step b1), where M is a fourth natural number greater than or equal to one,
d2) it receives the K cryptograms KA*_{k,20} and the digital fingerprint KA₂₀-Check transmitted by the first terminal,
e2) as long as at least one of the cryptograms KA*_{k,20} received has not been correctly decrypted, it successively reiterates the following steps, selecting on each occasion a new cryptogram chosen from the group consisting of the K cryptograms KA*_{k,20} received:
d2-1) it decrypts the selected cryptogram using one of the constructed keys KS_{m,22}, and thus obtains a key KA₂₂,
d2-2) it constructs a digital fingerprint KA₂₂-Check of this key KA₂₂, using the same hash function as that used in step e1),
d2-3) it compares this constructed fingerprint KA₂₂-Check with the fingerprint KA₂₀-Check received,
d2-4) if the digital fingerprints KA₂₀-Check and KA₂₂-Check are different, it returns to step d2-1) to re-execute steps d2-1) to d2-3), using a new key KS_{m,22}, and
d2-5) only if the digital fingerprints KA₂₀-Check and KA₂₂-Check are identical, the cryptogram KA*_{k,20} has been correctly decrypted, and it stores the key KA₂₂ as being the key identical to the key KA₂₀ which is now shared with the first terminal, this key KA₂₂ being usable to decrypt and encrypt the data exchanges between these two terminals.

14. A data recording medium readable by a cryptoprocessor or a microprocessor, wherein it comprises instructions for the implementation of a method as claimed in claim 1, when these instructions are executed by this cryptoprocessor or this microprocessor.

15. A first terminal for implementing a method as claimed in claim 1, wherein the first terminal is configured to execute the following steps:
a1) receiving the electromagnetic waves transmitted by the N wireless transmitters whose powers, at this first terminal, are above a first predetermined threshold Pₘᵢₙ₁ of detectability, N being a first natural number greater than or equal to one,
b1) extracting, by demodulation of the received electromagnetic waves, only the characteristic data elements transmitted by each of these N wireless transmitters,
c1) constructing an encryption key KS_{k,20} on the basis of at least one characteristic data element extracted in step b1), then
d1) encrypting the key KA₂₀ using the constructed encryption key KS_{k,20}, steps c) and d1) being reiterated for K distinct extracted characteristic data elements so as to obtain K different cryptograms KA*_{k,20}, where K is a second natural number greater than or equal to one,
e1) constructing a digital fingerprint KA₂₀-Check of the key KA₂₀, using a hash function,
f1) transmitting to the second terminal each of the K cryptograms KA*_{k,20} and the digital fingerprint KA₂₀-Check.

16. A second terminal for implementing a method as claimed in claim 1, wherein the second terminal is configured to execute the following steps:
a2) receiving the electromagnetic waves transmitted by the J wireless transmitters whose powers, at this second terminal, are above a second predetermined threshold Pₘᵢₙ₂ of detectability, J being a third natural number greater than or equal to one,
b2) extracting, by demodulation of the received electromagnetic waves, only the characteristic data elements transmitted by each of these J wireless transmitters,
c2) constructing M different keys KS_{m,22}, proceeding for each key KS_{m,22} in the same way as in step c1), but using the characteristic data elements extracted in step b2) in place of the characteristic data elements extracted in step b1), where M is a fourth natural number greater than or equal to one,
d2) receiving the K cryptograms KA*_{k,20} and the digital fingerprint KA₂₀-Check transmitted by the first terminal,
e2) as long as at least one of the cryptograms KA*_{k,20} received has not been correctly decrypted, successively reiterating the following steps, selecting on each occasion a new cryptogram chosen from the group consisting of the K cryptograms KA*_{k,20} received:
d2-1) decrypting the selected cryptogram using one of the constructed keys KS_{m,22}, thus obtaining a key KA₂₂,
d2-2) constructing a digital fingerprint KA₂₂-Check of this key KA₂₂, using the same hash function as that used in step e1),
d2-3) comparing this constructed fingerprint KA₂₂-Check with the fingerprint KA₂₀-Check received,
d2-4) if the digital fingerprints KA₂₀-Check and KA₂₂-Check are different, returning to step d2-1) to re-execute steps d2-1) to d2-3), using a new key KS_{m,22}, and
d2-5) only if the digital fingerprints KA₂₀-Check and KA₂₂-Check are identical, the cryptogram KA*_{k,20} has been correctly decrypted, and it stores the key KA₂₂ as being the key identical to the key KA₂₀ which is now shared with the first terminal, this key KA₂₂ being usable to decrypt and encrypt the data exchanges between these two terminals.
